(19) United States
(12) Patent Application Publication
(10) Pub. No.: US 2021/0168219 A1
(43) Pub. Date: Jun. 3, 2021

(54) RELAY DEVICE, DATA RELAY METHOD AND PROGRAM

(71) Applicant: NEC Corporation, Minato-ku, Tokyo (JP)

(72) Inventor: Tomotaka MASUDA, Tokyo (JP)

(73) Assignee: NEC Corporation, Minato-ku, Tokyo (JP)

(21) Appl. No.: 17/048,358

(22) PCT Filed: Apr. 16, 2019
(86) PCT No.: PCT/JP2019/016247

§ 371 Date: Oct. 16, 2020

(30) Foreign Application Priority Data
Apr. 17, 2018 (JP) 2018-078872

(51) Int. Cl. H04L 29/08; H04L 12/24; H04L 29/12

(52) U.S. Cl. CPC H04L 67/2814; H04L 67/2866; H04L 61/6063; H04L 41/5003; H04L 67/1078

(57) ABSTRACT

To suppress reduction in facility utilization efficiency occurring on for a communication carrier and reduction in feeling quality occurring on users caused by a relay device arranged at a boundary between two networks comprising a mobile network. The relay device comprises a proxy part that terminates each of TCP communications with a data providing side apparatus and with a data transmission destination apparatus to be a transmission destination of data received from the data providing side apparatus; a transmission buffer that stores data to be transmitted to the data transmission destination apparatus among data received from the data providing side apparatus; a reception ability prospecting part that prospects reception ability of the data transmission destination apparatus based on vacant volume of the transmission buffer; and a transfer rate control part that instructs the data providing side apparatus of a transfer rate based on the reception ability of the data transmission destination apparatus.

### CROSS-REFERENCE TO RELATED APPLICATION

The present invention is based on priority of JP Patent Application No. 2018-078872 (filed on Apr. 17, 2018). The entire contents thereof are incorporated by reference into the present application.

### FIELD

The present invention relates to a relay device, a relay method, and a program.

### BACKGROUND

It is a general configuration of an internet connection via a mobile network that a relay device is arranged on a boundary of both networks so as to terminate TCP (Transmission Control Protocol) in order to suppress worsening of communication quality due to difference in network properties. In the relay device of this type, it is required to set a relevant setting value of a window size and the like for notifying a transmission source of data volume capable of being received at once by a reception side together with network throughput. In a case where this window size or the like is not relevantly set, there is a possibility that sufficient speeding up is not realized nor yet that communication speed is worsened due to occurrence of packet loss.

A packet loss base scheme, a delay base scheme, and a hybrid scheme of a combination thereof are known as a congestion control algorithm for TCP. In the packet loss base scheme, packet loss is monitored, increase in the loss is regarded as occurrence of congestion, and then transmission volume is suppressed, which is exemplified by a CUBIC algorithm or the like. In the delay base scheme, packet delay is monitored, increase in delay volume is determined as occurrence of congestion state, and then transmission volume is reduced, which is exemplified by Westwood+scheme or the like.

In addition, Patent Literatures 1 to 3 disclose a configuration in which congestion window value and a window size are changed. Patent Literature 1 discloses a base station capable of improving throughput after avoiding congestion. According to the same literature, the base station comprises a transmission buffer 251 for accumulating TCP packets to be transmitted from the base station to a communication terminal via a radio link. In addition, the base station comprises a congestion control part 245 that controls the volume of TCP packet entering the transmission buffer 251 based on the minimum window value among a congestion window value and a reception window value reported from the communication terminal. Further, the base station comprises a congestion window value setting part 243 that reduces the congestion window value to a predetermined value when an accumulation volume of the TCP packets in the transmission buffer 251 reaches a threshold or more. Further, the congestion window value setting part 243 sets the congestion window value at a value which is higher than the predetermined value and equal to or more than the reception window value when the accumulation volume of the TCP packets in the transmission buffer 251 is reduced to a value lower than the threshold after reduction of the congestion window value.

Patent Literature 2 discloses a communication apparatus capable of preventing reduction in throughput. According to the same literature, the communication apparatus comprises a transmission buffer 14 that accumulates transmission packets output from a packet processing part 15 and outputs the transmission packets to a communication part 11 under control by a buffer control part 16. In addition, the communication apparatus comprises a buffer monitoring part 13 that monitors vacant volume (free volume) of the transmission buffer 14 at all the time, and outputs a monitoring result to a window size changing part 12. Further, the communication apparatus comprises the window size changing part 12 that changes a window size notified by another communication apparatus using an ACK packet based on the vacant volume of the transmission buffer 14. Further, the communication apparatus comprises a packet processing part 15 that generates new transmission packets within an upper limit of the changed window size and outputs them to the transmission buffer 14.

In addition, Patent Literature 3 discloses a congestion control node apparatus that executes congestion control of a layer-2 switch which executes flow control.

### CITATION LIST

### Patent Literature

Patent Literature 1: JP Patent Kokai Publication No. JP2016-208193A
Patent Literature 2: JP Patent Kokai Publication No. JP2015-095780A
Patent Literature 3: JP Patent Kokai Publication No. JP2009-060283A

### SUMMARY

### Technical Problem

The following analyses have been made by the present invention. There are problems that, as a result of re-transmission and reduction in throughput due to packet loss in the relay device described above, reduction in facility utilization efficiency occurs for a communication carrier and reduction in feeling quality occurs for users.

As to this point, Patent Literature 1, at paragraph 0040, discloses that it is difficult for a transmission source to comprehend the packet accumulation volume in the transmission buffer of a relay node. In addition, the same paragraph merely discloses that congestion window value is gradually increased so that the packet loss due to overflow of the buffer does not occur in the relay node frequently.

In addition, Patent Literature 2 discloses a method in which a window size notified by a transmission destination is rewritten based on the vacant volume of the transmission buffer in the communication terminal at the transmission side of data packet. It is the same as Patent Literature 1 that it is difficult to comprehend packet congestion volume in the transmission buffer of the relay node.

It is a purpose of the present invention to provide a relay device, a data relay method and a program capable of contributing to suppress reduction of the facility utilization efficiency and reduction of the user feeling quality due to a relay device arranged at a boundary of two networks comprising a mobile network.

### Solution to Problem

According to a first aspect, there is provided a relay device, comprising a proxy part that terminates each of TCP (Transmission Control Protocol) communications with a data providing side apparatus and with a data transmission destination apparatus to be a transmission destination of data received from the data providing side apparatus; a transmission buffer storing data to be transmitted to the data transmission destination apparatus among data received from the data providing side apparatus; a reception ability prospecting part that prospects reception ability of the data transmission destination apparatus based on vacant volume of the transmission buffer; and a transfer rate control part that instructs the data providing side apparatus of a transfer rate based on the reception ability of the data transmission destination apparatus.

According to a second aspect, there is provided a data relay method, wherein a relay device comprising: a proxy part that terminates each of TCP communications with a data providing side apparatus and with a data transmission destination apparatus to be a transmission destination of data received from the data providing side apparatus; and a transmission buffer storing data to be transmitted to the data transmission destination apparatus among data received from the data providing side apparatus, and transmitting data received from the data providing side apparatus to the data transmission destination apparatus is configured to perform steps comprising: a step of prospecting reception ability of the data transmission destination apparatus based on vacant volume of the transmission buffer, and a step of instructing the data providing side apparatus of a transfer rate based on the reception ability of the data transmission destination apparatus. The method is related to a specific machine as a relay device arranged on a boundary of a mobile network and a core network.

According to a third aspect, there is provided a program, causing a computer installed in a relay device comprising: a proxy part that terminates each of TCP communications with a data providing side apparatus and with a data transmission destination apparatus to be a transmission destination of data received from the data providing side apparatus; and a transmission buffer storing data to be transmitted to the data transmission destination apparatus among data received from the data providing side apparatus, and transmitting data received from the data providing side apparatus to the data transmission destination apparatus, and transmitting data received from the data providing side apparatus to the data transmission destination apparatus, to execute the following processes: a process of prospecting reception ability of the data transmission destination apparatus based on vacant volume of the transmission buffer, and a process of instructing the data providing side apparatus of a transfer rate based on the reception ability of the data transmission destination apparatus. Herein, the program may be stored in a storage medium which may be read by a computer (non-transitory). That is, the present invention may be realized as a computer program product.

### Advantageous Effects of Invention

According to the present invention, reduction of the facility utilization efficiency and reduction of the user feeling quality due to a relay device arranged at a boundary of two networks comprising a mobile network may be suppressed.

### BRIEF DESCRIPTION OF THE DRAWINGS

FIG. 1 is a diagram showing a configuration of one exemplary embodiment of the present invention.

FIG. 2 is a diagram showing a configuration of a first exemplary embodiment of the present invention.

FIG. 3 is an explanatory flow diagram of operations executed by a relay device of the first exemplary embodiment of the present invention.

FIG. 4 is an explanatory view of vacant volume of a transmission buffer of a relay device of the first exemplary embodiment of the present invention.

FIG. 5 is an explanatory view of a prospecting method of a reception ability of a counter-part apparatus by the relay device of the first exemplary embodiment of the present invention.

FIG. 6 is another explanatory view of a prospecting method of a reception ability of a counter-part apparatus by the relay device of the first exemplary embodiment of the present invention.

FIG. 7 is another explanatory view of change in the transmission buffer in a case where the reception ability of the counter-part apparatus is at a reduced level.

FIG. 8 is another explanatory view of change in the transmission buffer in a case where the reception ability of the counter-part apparatus is abundant.

FIG. 9 is a diagram showing a configuration of a second exemplary embodiment of the present invention.

FIG. 10 is an explanatory flow diagram of operations executed by the relay device of the second exemplary embodiment of the present invention.

FIG. 11 is a diagram showing a configuration of a computer configuring the relay device of the present invention.

### MODES

First, an outline of one exemplary embodiment of the present invention will be explained while referring to drawings. Herein, reference signs described in the outline is expediently appended to each element as one example for an explanatory aid for understanding, but not for limitation of the present invention to a configuration illustrated in the drawings. In addition, a connection line between blocks in the drawings and the like referred to in the following explanation comprises both of bidirection and single direction. One-way arrow schematically indicates a main signal (data) flow, but not excluding bidirectional flows.

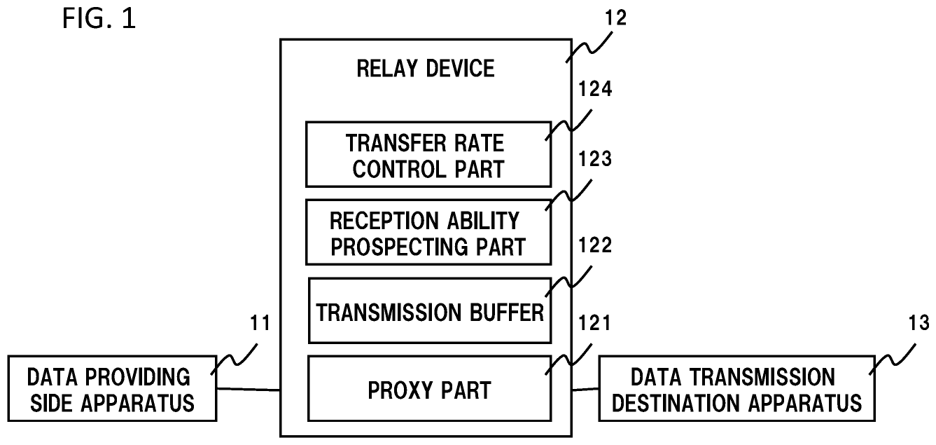

In one exemplary embodiment, the present invention is realized by a relay device 12 that relays data transmitted from a data providing side apparatus 11 to a data transmission destination apparatus 13 as illustrated in FIG. 1. More concretely, the relay device 12 comprises a proxy part 121, a transmission buffer 122, a reception ability prospecting part 123 and a transfer rate control part 124.

The proxy part 121 terminates each of TCP communications between the data providing side apparatus 11 and own device (the relay device 12) and TCP communications between own device (the relay device 12) and the data transmission destination apparatus 13.

The transmission buffer 122 stores pre-transmission data (data not transmitted yet) to be transmitted to the data transmission destination apparatus, and data of pre-ACK reception (before reception acknowledgement) after transmission.

The reception ability prospecting part 123 prospects reception ability of the data transmission destination apparatus 13 based on vacant volume (free volume) of the transmission buffer 122.

In addition, the transfer rate control part 124 instructs the data providing side apparatus 11 of a transfer rate based on the prospected reception ability of the data transmission destination apparatus 13. The instruction of the transfer rate may be realized by, for example, designating a window size in a TCP header of ACK (reception acknowledgement) transmitted to the data providing side apparatus 11.

According to the exemplary embodiment above, occurrence of packet loss and delay may be suppressed between own device (the relay device 12) and the data transmission destination apparatus 13. It is because such a configuration is adopted, that an omen of occurrence of packet loss and/or delay is comprehended based on the vacant volume of the transmission buffer, and the transfer rate is changed at an early stage.

### First Exemplary Embodiment

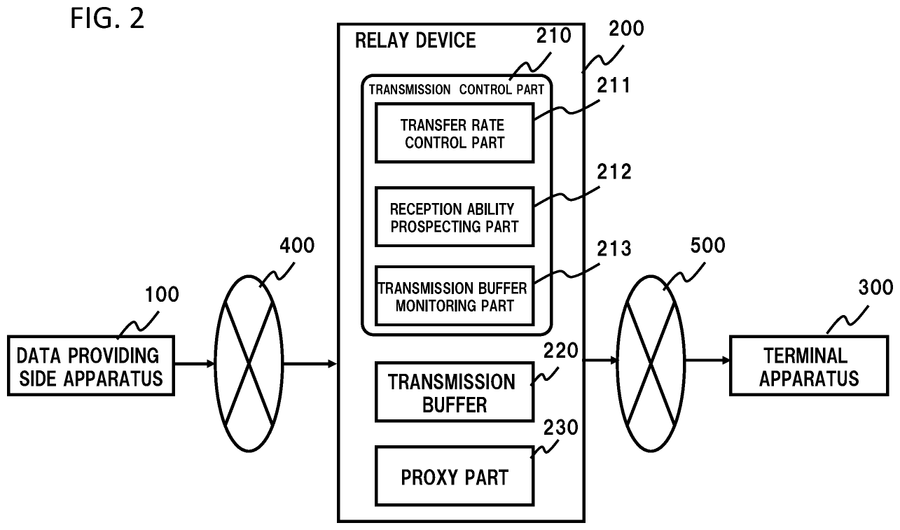

Next, a first exemplary embodiment of the present invention will be explained in detail while referring to the drawings. FIG. 2 is a diagram showing a configuration of the first exemplary embodiment of the present invention. Referring to FIG. 2, illustrated is a relay device 200 arranged at a boundary of networks 400, 500 to which a data providing side apparatus 100 and a terminal apparatus 300 are connected, respectively.

The data providing side apparatus 100 comprises, for example, a server and the like arranged on an internet or a cloud service platform.

The terminal apparatus 300 comprises a smartphone, a personal computer (PC), an IoT (Internet of Thing) apparatus and the like which receive data from the data providing side apparatus 100 via the networks 400, 500.

The network 400 comprises, for example, an internet or a local area network. On the other hand, the network 500 comprises a radio access network. The network 500 has a high tendency of occurrence of packet loss and/or delay due to change in radio quality and the like as compared to the network 400, thus the relay device 200 is arranged. The relay device 200 provides TCP connections to each of the data providing side apparatus 100 and the terminal apparatus 300, and communicates with them depending on their network properties, respectively.

Referring to FIG. 2, the relay device 200 comprises a transmission control part 210, a transmission buffer 220 and a proxy part 230.

The transmission control part 210 comprises a transfer rate control part 211, a reception ability prospecting part 212 and a transmission buffer monitoring part 213.

The proxy part 230 provides TCP connections to each of the data providing side apparatus 100 and the terminal apparatus 300 and communicates with them depending on their network properties, respectively. More concretely, the proxy part 230 transmits data to the side of the terminal apparatus 300 based on a window size which has been notified from a reception side apparatus (i.e., the terminal apparatus 300 herein). In addition, the proxy part 230 is also configured to notify a data providing side apparatus 100 of a window size which has been determined by the transmission control part 210.

The transmission buffer 220 is a buffer for accumulating data destined to the terminal apparatus 300, which has been received from the data providing side apparatus 100.

The transmission control part 210 comprises the transfer rate control part 211, the reception ability prospecting part 212 and the transmission buffer monitoring part 213.

The transmission buffer monitoring part 213 periodically monitors vacant volume of the buffer and transmits a result thereby to the reception ability prospecting part 212.

The reception ability prospecting part 212 prospects the reception ability of a reception side apparatus (i.e., the terminal apparatus 300 herein) based on the change in the vacant volume of the buffer which has been received from the transmission buffer monitoring part 213. The reception ability prospecting part 212 transmits the prospected reception ability of the reception side apparatus (i.e., the terminal apparatus 300 herein) to the transfer rate control part 211.

The transfer rate control part 211 determines a window size to be notified to the data providing side apparatus 100 based on the prospected reception ability of the reception side apparatus (i.e., the terminal apparatus 300 herein) which has been received from the reception ability prospecting part 212. Herein, in addition to the above described matter, the transfer rate control part 211 may increase or decrease the window size which has been received from the reception side apparatus (i.e., the terminal apparatus 300 herein) based on the prospected reception ability of the reception side apparatus (i.e., the terminal apparatus 300 herein).

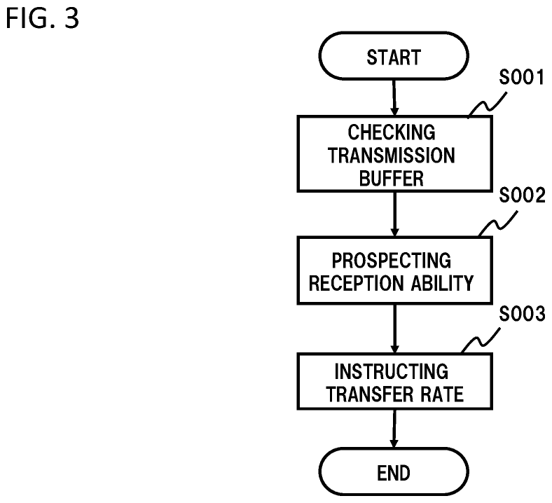

Next, operations of the present exemplary embodiment will be explained in detail while referring to drawings. FIG. 3 is an explanatory flow diagram of operations executed by the relay device of the first exemplary embodiment of the present invention, which are periodically operated by every predetermined time cycle after establishment of TCP connection(s). Referring to FIG. 3, first, the relay device 200 acquires vacant volume of the transmission buffer 220 destined to the terminal apparatus (step S001).

Next, the relay device 200 prospects the reception ability of the reception side apparatus (i.e., the terminal apparatus 300 herein) using change in the vacant volume of the transmission buffer 220 (step S002).

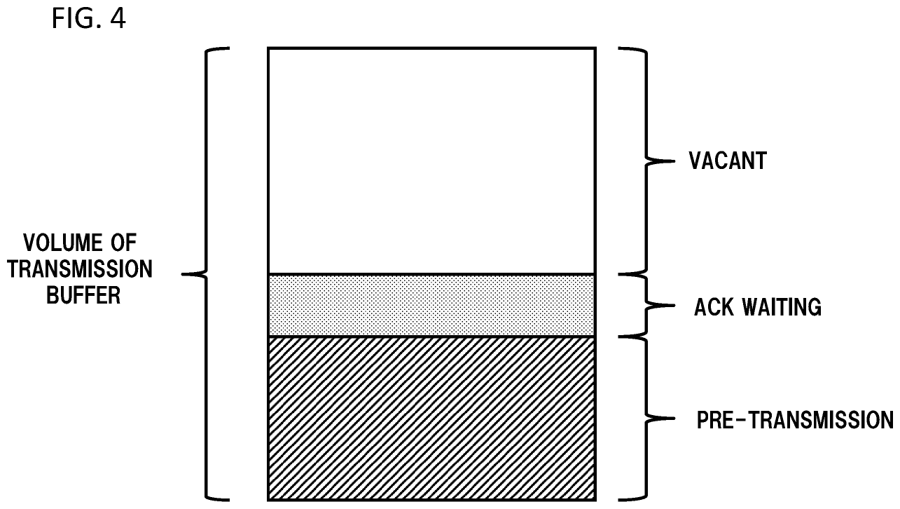

Herein, the vacant volume of the transmission buffer 220 is defined as follows. FIG. 4 is an explanatory view of the vacant volume of the transmission buffer 220 of the relay device 200 of the present exemplary embodiment. As illustrated in FIG. 4, data destined to the terminal apparatus 300, which has been received by the relay device 200 from the data providing side apparatus 100, is stored in the transmission buffer 220. In FIG. 4, “pre-transmission” refers to data which has not been transmitted to the terminal apparatus 300. After that, when the relay device 200 obtains data from the transmission buffer 220 and transmits it, the data shifts from pre-transmission state to ACK waiting state. Subsequently, when receiving ACK from the terminal apparatus 300, the data is deleted from the transmission buffer. Therefore, the vacant volume of the transmission buffer 220 may be obtained by subtracting from the volume of the transmission buffer 220 the volume at which the pre-transmission data is stored (“pre-transmission” in FIG. 4) and the volume at which ACK waiting data of pre-ACK reception after transmission is stored (“ACK waiting” in FIG. 4). In addition, as described above, the vacant volume of the transmission buffer 220 would be changed depending on data reception state of a counter-part apparatus.

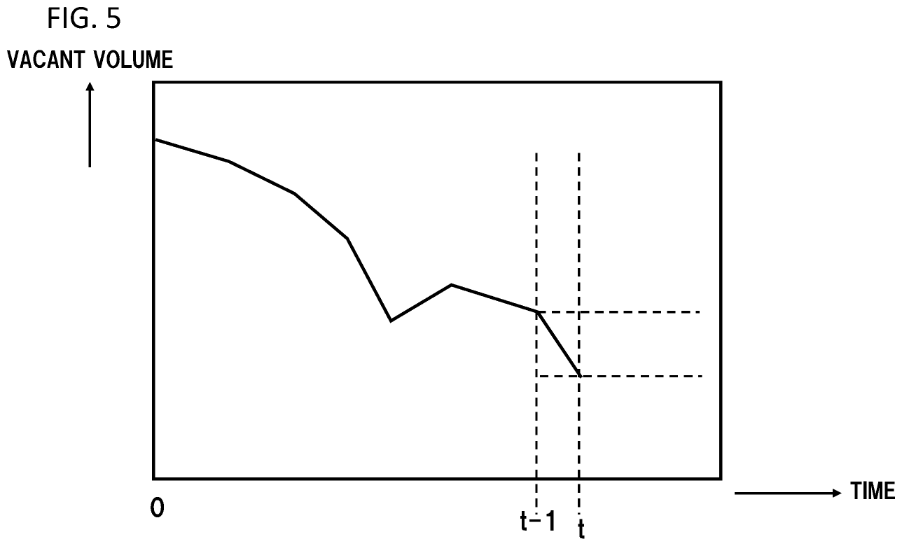

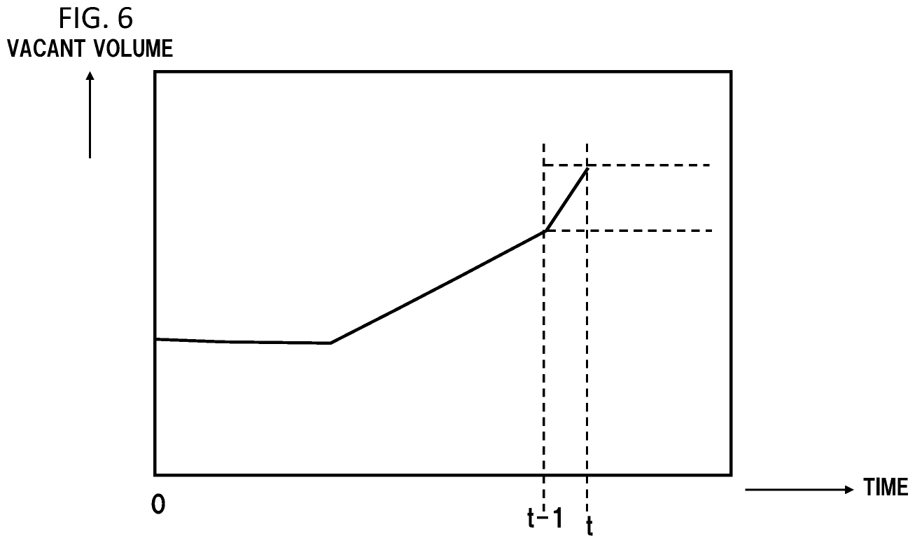

FIG. 5 and FIG. 6 are explanatory views of a prospecting method of the reception ability of a counter-part apparatus by the relay device 200. In an example of FIG. 5, illustrated is a state where the vacant volume is reduced at a certain time point t as compared with the vacant volume at a timing of a preceding check time point (time point t−1). This figure represents a situation where whole data transmitted from the relay device 200 is not processed by the reception side apparatus (i.e., the terminal apparatus 300 herein). In such case, the relay device 200 determines that the reception ability of the reception side apparatus (i.e., the terminal apparatus 300 herein) is under a lower state in comparison with a data transfer rate based on a current window size.

In an example of FIG. 6, illustrated is a state where the vacant volume is increased at a certain time point t as compared with the vacant volume at a timing of a preceding check time point (time point t−1). This figure represents a situation where data transmitted from the relay device 200 is sufficiently processed by the reception side apparatus (i.e., the terminal apparatus 300 herein). In such case, the relay device 200 determines that the reception ability of the reception side apparatus (i.e., the terminal apparatus 300 herein) is under a higher state in comparison with a data transfer rate based on a current window size.

Next, the relay device 200 changes the transfer rate based on the prospect reception ability of the reception side apparatus (i.e., the terminal apparatus 300 herein) and instructs the data providing side apparatus 100 of it (step S003). For example, in a case where it is determined that the reception ability of the terminal apparatus 300 is in a lower state in comparison with a data transfer rate based on a current window size as illustrated in FIG. 5, the relay device 200 instructs the data providing side apparatus 100 to execute transmission at a data transfer rate lower than the current rate.

Similarly, in a case where it is determined that the reception ability of the terminal apparatus 300 is in a higher state in comparison with a data transfer rate based on a current window size as illustrated in FIG. 6, the relay device 200 instructs the data providing side apparatus 100 to execute transmission at a data transfer rate higher than the current rate.

Herein, the instruction of the data transfer rate in the above described step S003 may be executed by a method in which a value corresponding to the data transfer rate is set in a window size field of a header upon ACK transmission to the data providing side apparatus 100.

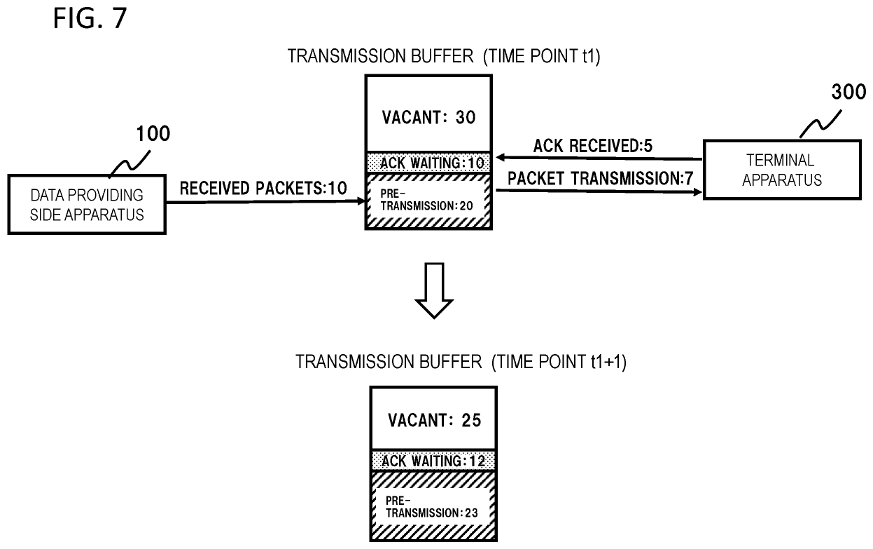

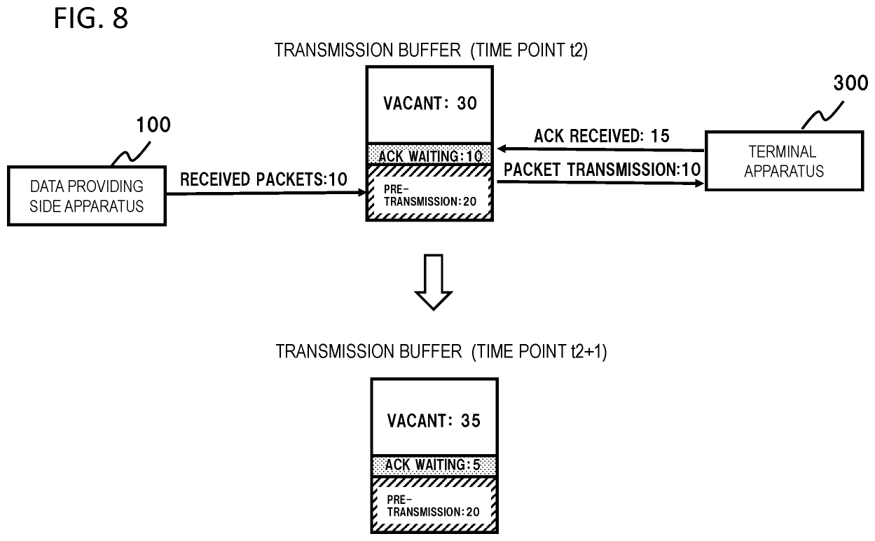

Herein, concrete examples of determination of the data transfer rate will be explained while referring to FIG. 7 and FIG. 8. As illustrated in FIG. 7, it is assumed that the transmission buffer 220 stores 20 units of pre-transmission data and 10 units of ACK waiting data, and has 30 units of vacant volume at a certain time point t1. Then, the relay device 200 receives 10 units of packets from the data providing side apparatus 100 within a certain unit-time. On the other hand, the relay device 200 transmits 7 units of packet to the terminal apparatus 300 and receives 5 units of ACK. As a result, at a next timing for monitoring the transmission buffer (time point t1+1), 10 units are added to the pre-transmission data and 7 units are subtracted from it, thus the pre-transmission data is calculated as 20+(10−7)=23 units. On the other hand, 7 units are added to the ACK waiting data and 5 units are subtracted from it, thus the ACK waiting data is calculated as 10+(−5+7)=12 units. As a result, the vacant volume is reduced from 30 units to 25 units. In such case, the reception ability of the terminal apparatus 300 is prospected as 5 units per one unit-time, thus the relay device 200 instructs the data providing side apparatus 100 to bring the transmission rate to approach 5 units. Thereby, occurrence of congestion and packet loss may be avoided between the relay device 200 and the terminal apparatus 300.

On the other hand, as illustrated in FIG. 8, it is assumed that the transmission buffer 220 stores 20 units of pre-transmission data and 10 units of ACK waiting data, and has 30 units of vacant volume at a certain time point t2. Then, the relay device 200 receives 10 units of packets from the data providing side apparatus 100 within a certain unit-time. On the other hand, the relay device 200 transmits 10 units of packet to the terminal apparatus 300 and receives 15 units of ACK. As a result, at a next timing for monitoring the transmission buffer (time point t2+1), 10 units are added to the pre-transmission data and 10 units are subtracted from it, thus the pre-transmission data is calculated as 20 units. On the other hand, 10 units are added to the ACK waiting data and 15 units are subtracted from it, thus the ACK waiting data is calculated as 5 units. As a result, the vacant volume is increased from 30 units to 35 units. In such case, the reception ability of the terminal apparatus 300 is prospected as 15 units per one unit-time, thus the relay device 200 instructs the data providing side apparatus 100 to bring the transmission rate to approach 15 units. Thereby, entire throughput may be improved.

As described above, according to the present exemplary embodiment, the data transfer rate between the data providing side apparatus 100 and the relay device 200 may be changed before occurrence of re-transmission between the relay device 200 and the terminal apparatus 300. Thereby, unnecessary packet transmission (re-transmission and pause frame) may be suppressed, too.

Further, according to the present exemplary embodiment, excessive increase or decrease in the data transfer rate may be avoided, thus resources in the entire network may be effectively used while considering the other communication. Furthermore, the data transfer rate may be gradually changed, thus there is an advantage that no severe effects are provided onto user's feeling on service level.

### Second Exemplary Embodiment

In the above described exemplary embodiment, the transfer rate of the upstream side apparatus is changed based on the reception ability of the reception side apparatus (i.e., the terminal apparatus 300 herein). However, similar effect may be exerted by changing the service level. Herein, the service level refers to: difference in compression level involving presence or absence of compression of image in a service from the data providing side apparatus 100 to the terminal apparatus 300: difference in data encoding manner, level (high/low) in bit rate of movie to be provided; and the like.

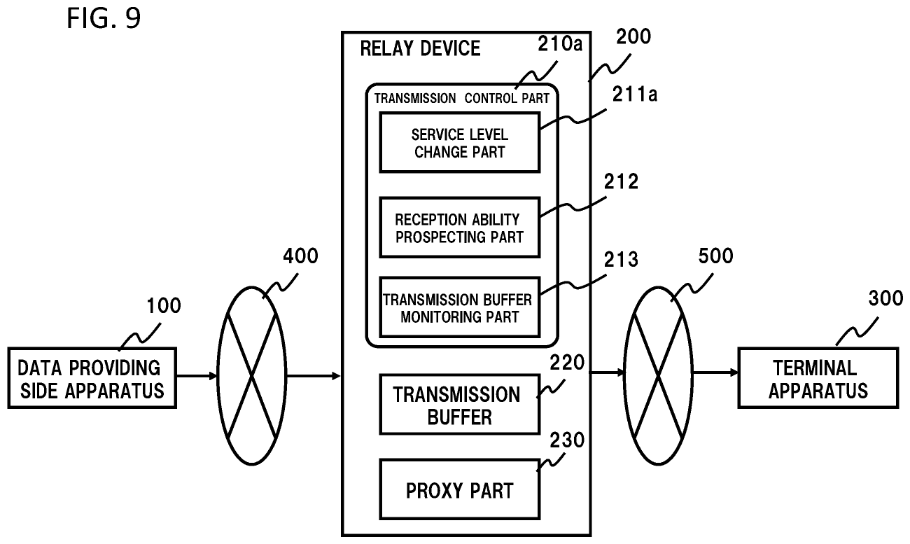

FIG. 9 is a diagram showing a configuration of a second exemplary embodiment of the present invention. Difference in configuration from the first exemplary embodiment illustrated in FIG. 2 resides in a point that the transfer rate control part 211 in the transmission control part 210a is replaced with a service level change part 211a. The other configuration is similar to that of the first exemplary embodiment, thus explanation thereof is omitted.

The service level change part 211a determines a service level of the data providing side apparatus 100 based on the prospected reception ability of the reception side apparatus (i.e., the terminal apparatus 300 herein), which has been received from the reception ability prospecting part 212, and notifies the side of the data providing side apparatus 100 of it.

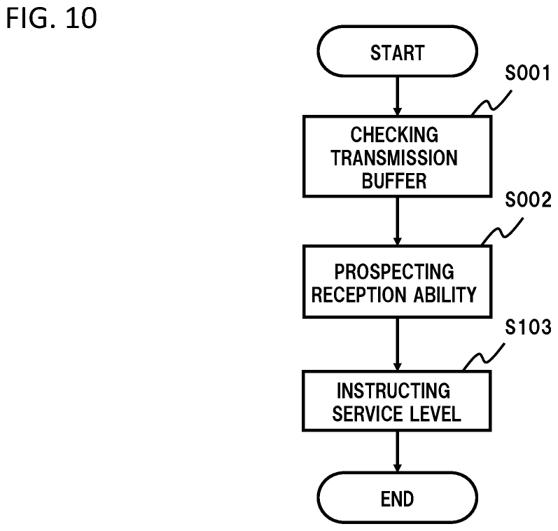

FIG. 10 is an explanatory flow diagram of operations executed by the relay device of the second exemplary embodiment. Different point from the operations exerted by the relay device of the first exemplary embodiment illustrated in FIG. 3 resides a point that the instruction of service level is executed in step S103.

For example, in a case where the state of the transmission buffer is changed as illustrated in FIG. 5, the relay device 200a determines at a time point t that the reception ability of the reception side apparatus (i.e., the terminal apparatus 300 herein) is at a lower state in comparison with the data transfer rate based on a current window size. Therefore, the relay device 200a of the present exemplary embodiment instructs the providing side apparatus 100 to reduce the service level. Thereby, the volume of data transmitted from the data providing side apparatus 100 to the side of the terminal apparatus 300 is reduced, thus occurrence of congestion and packet loss may be avoided between the relay device 200 and the terminal apparatus 300.

In a case where the state of the transmission buffer is changed as illustrated in FIG. 6, the relay device 200a determines at a time point t that the reception ability of the reception side apparatus (i.e., the terminal apparatus 300 herein) is at a higher state in comparison with the data transfer rate based on a current window size. Therefore, the relay device 200a of the present exemplary embodiment instructs the providing side apparatus 100 to increase the service level. Thereby, the service level received by the terminal apparatus 300 is improved.

Herein, in the above described exemplary embodiment, explained is a case where only the service level is changed. However, the data transfer rate may be also changed together with the change in the service level.

As described above, although the exemplary embodiments of the present invention are explained, the present invention is not limited to the exemplary embodiments above. Further modification, replacement and adjustment may be added thereto within a range not-deviating from a technical concept of the present invention. For example, a network configuration illustrated in each figure, a configuration of each elements, expressed state of a message are a mere example of an explanatory aid for understanding the present invention, thus they are not limited to a configuration illustrated in these figures. In addition, a phrase “A and/or B” is used as meaning at least any one of A and B in the following explanation.

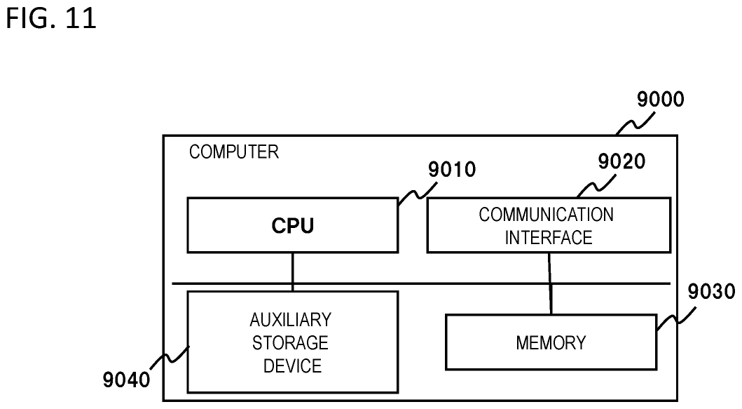

Further, the steps indicated in the above first and second exemplary embodiments may be realized by a program which causes a computer acting as the relay device 200, 200a (9000 in FIG. 11) to realize functions as the relay device 200. Such computer is exemplified by a configuration illustrated in FIG. 11, which comprises CPU (Central Processing Unit) 9010, a communication interface 9020, a memory 9030, and an auxiliary storage device 9040. That is, the CPU 9010 in FIG. 11 executes a transmission buffer monitoring program, a reception ability prospecting program, a transfer control program, and executes an update process of each calculation parameter stored in the auxiliary storage device 9040.

In other words, each part (processing means, function) of the relay devices 200, 200a indicated in the above first, second exemplary embodiments may be realized by a computer program which causes a processor installed in a relay device to execute each process described above using its hardware.

Last, preferable modes of the present invention are summarized.

### [First Mode]

(See the relay device according to the first aspect above.)

### [Second Mode]

The transfer rate control part of the above relay device may adopt a mode of instructing the transfer rate by change-instruction of a window size to the data providing side apparatus.

### [Third Mode]

The transfer rate control part of the above relay device may adopt a mode of changing the transfer rate to the data transmission destination apparatus based on the reception ability of the data transmission destination apparatus.

### [Fourth Mode]

It is preferable that the above relay device instructs a transfer rate of a value smaller than a current transfer rate in a case where it is indicated that the vacant volume of the transmission buffer is at a reduced level.

### [Fifth Mode]

It is preferable that the above relay device instructs a transfer rate of a value larger than a current transfer rate in a case where it is indicated that the vacant volume of the transmission buffer is at an increased level.

### [Sixth Mode]

The above relay device may adopt a construction of instructing the data providing side apparatus to change a service level based on the reception ability of the data transmission destination apparatus.

### [Seventh Mode]

The above relay device may adopt, instead of the transfer rate control part, a configuration of comprising a service level change part that instructs the data providing side apparatus to change a service level based on the reception ability of the data transmission destination apparatus.

### [Eighth Mode]

(See the data relay method according to the second aspect above.)

### [Ninth Mode]

(See the program according to the third aspect above.)
   Herein, the eighth to ninth modes may be developed to second to seventh modes likewise as the first mode.

Each disclosure of the above Patent Literatures is incorporated herein by reference thereto. Variations and adjustments of the exemplary embodiment and examples are possible within the ambit of the entire disclosure (including the claims) of the present invention and based on the basic technical concept of the present invention. Various combinations and selections (including non-selection) of various disclosed elements (including each element in each claim, each exemplary embodiment, each example, each drawing, etc.) are possible within the ambit of the disclosure of the present invention. Namely, the present invention of course includes various variations and modifications that could be made by those skilled in the art according to the overall disclosure including the claims and the technical concept.

Particularly, a numerical value range described in the present description should be interpreted as describing arbitrary numerical values or small ranges included in the ranges, even if they are not described explicitly.

### REFERENCE SIGNS LIST

11, 100 data providing side apparatus
12, 200, 200a relay device
13 data transmission destination apparatus
121, 230 proxy part
122, 220 transmission buffer
123 reception ability prospecting part
124 transfer rate control part
100 data providing side apparatus
210, 210a transmission control part
211 transfer rate control part
211a service level change part
212 reception ability prospecting part
213 transmission buffer monitoring part
300 terminal apparatus
400, 500 network
9000 computer
9010 CPU
9020 communication interface
9030 memory
9040 auxiliary storage device

What is claimed is:

1. A relay device, comprising:
a proxy part that terminates each of TCP (Transmission Control Protocol) communications with a data providing side apparatus and with a data transmission destination apparatus to be a transmission destination of data received from the data providing side apparatus;
a transmission buffer that stores data to be transmitted to the data transmission destination apparatus among data received from the data providing side apparatus;
a reception ability prospecting part that prospects reception ability of the data transmission destination apparatus based on vacant volume of the transmission buffer; and
a transfer rate control part that instructs the data providing side apparatus of a transfer rate based on the reception ability of the data transmission destination apparatus.

2. The relay device according to claim 1, wherein
the transfer rate control part instructs the transfer rate by change-instruction of a window size to the data providing side apparatus.

3. The relay device according to claim 1, wherein
the transfer rate control part further changes the transfer rate to the data transmission destination apparatus based on the reception ability of the data transmission destination apparatus.

4. The relay device according to claim 1, wherein
a transfer rate of a value smaller than a current transfer rate in a case where it is indicated that the vacant volume of the transmission buffer is at a reduced level.

5. The relay device according to claim 1, wherein
a transfer rate of a value larger than a current transfer rate in a case where it is indicated that the vacant volume of the transmission buffer is at an increased level.

6. The relay device according to claim 1, further comprising:
a service level change part that instructs the data providing side apparatus to change a service level based on the reception ability of the data transmission destination apparatus.

7. The relay device according claim 1, comprising, instead of the transfer rate control part:
a service level change part that instructs the data providing side apparatus to change a service level based on the reception ability of the data transmission destination apparatus.

8. A data relay method, comprising
terminating each of TCP (Transmission Control Protocol) communications with a data providing side apparatus and with a data transmission destination apparatus to be a transmission destination of data received from the data providing side apparatus;
storing data to be transmitted to the data transmission destination apparatus among data received from the data providing side apparatus;
transmitting data received from the data providing side apparatus to the data transmission destination apparatus;
prospecting reception ability of the data transmission destination apparatus based on vacant volume of the transmission buffer, and
instructing the data providing side apparatus of a transfer rate based on the reception ability of the data transmission destination apparatus.

9. The data relay method according to claim 8, comprising
instructing the transfer rate by changing a window size in a TCP header of a packet to be transmitted to the data providing side apparatus.

10. A non-transient computer-readable storage medium storing a program, wherein the program causes a computer installed in a relay device comprising: a proxy part that terminates each of TCP (Transmission Control Protocol) communications with a data providing side apparatus and with a data transmission destination apparatus to be a transmission destination of data received from the data providing side apparatus; and a transmission buffer storing data to be transmitted to the data transmission destination apparatus among data received from the data providing side apparatus, and transmitting data received from the data providing side apparatus to the data transmission destination apparatus, and transmitting data received from the data providing side apparatus to the data transmission destination apparatus, to execute the following processes:
a process of prospecting reception ability of the data transmission destination apparatus based on vacant volume of the transmission buffer, and
a process of instructing the data providing side apparatus of a transfer rate based on the reception ability of the data transmission destination apparatus.

11. The data relay method according to claim 8, comprising
instructing the transfer rate by change-instruction of a window size to the data providing side apparatus.

12. The data relay method according to claim 8, comprising
changing the transfer rate to the data transmission destination apparatus based on the reception ability of the data transmission destination apparatus.

13. The data relay method according to claim 8, wherein
a transfer rate of a value smaller than a current transfer rate in a case where it is indicated that the vacant volume of the transmission buffer is at a reduced level.

14. The data relay method according to claim 8, wherein
a transfer rate of a value larger than a current transfer rate in a case where it is indicated that the vacant volume of the transmission buffer is at an increased level.

15. The data relay method according to claim 8, further comprising
instructing the data providing side apparatus to change a service level based on the reception ability of the data transmission destination apparatus.

16. The data relay method according to claim 8, further comprising
instructing the data providing side apparatus to change a service level based on the reception ability of the data transmission destination apparatus.

17. The non-transient computer-readable storage medium according to claim 10, causing the computer to execute:
a process of instructing the transfer rate by change-instruction of a window size to the data providing side apparatus.

18. The non-transient computer-readable storage medium according to claim 10, causing the computer to execute:
a process of changing the transfer rate to the data transmission destination apparatus based on the reception ability of the data transmission destination apparatus.

19. The non-transient computer-readable storage medium according to claim 10, wherein
a transfer rate of a value smaller than a current transfer rate in a case where it is indicated that the vacant volume of the transmission buffer is at a reduced level.

20. The non-transient computer-readable storage medium according to claim 10, wherein
a transfer rate of a value larger than a current transfer rate in a case where it is indicated that the vacant volume of the transmission buffer is at an increased level.
